(19) United States
(12) Patent Application Publication
(10) Pub. No.: US 2015/0142937 A1
(43) Pub. Date: May 21, 2015

(54) METHOD AND SYSTEM FOR REMOTE EQUIPMENT DATA INSTALLATION

(71) Applicant: LITE-ON CLEAN ENERGY TECHNOLOGY CORP., TAIPEI (TW)

(72) Inventor: PING-KUANG CHANG, TAIPEI (TW)

(73) Assignee: LITE-ON CLEAN ENERGY TECHNOLOGY CORP., TAIPEI (TW)

(21) Appl. No.: 14/141,634

(22) Filed: Dec. 27, 2013

(30) Foreign Application Priority Data
Nov. 18, 2013 (TW) 102141927
Nov. 18, 2013 (TW) 102221514

(51) Int. Cl. H04L 12/24; H04W 4/00

(52) U.S. Cl. CPC H04L 41/0806; H04W 4/008
USPC 709/222

(57) ABSTRACT

In a method and system for data installation, a mobile device acquires a unique identification code from a remote equipment, communicates with an equipment management server, which is located remotely with respect to the remote equipment, via a communication network to obtain from the equipment management server installation data corresponding to the remote equipment, and transmits the installation data to the remote equipment upon establishing a short-distance wireless communication link with the remote equipment such that the remote equipment performs initial installation of the installation data.

### CROSS-REFERENCE TO RELATED APPLICATION

This application claims priority to Taiwanese Application Nos. 102141927 and 102221514, both filed on Nov. 18, 2013, the contents of which are hereby incorporated by reference.

### BACKGROUND OF THE INVENTION

1. Field of the Invention

The invention relates to equipment data installation, and more particularly to a method and system for remote equipment data installation.

2. Description of the Related Art

The increasing popularity of electric vehicles has resulted in an increase in public electrical outlets to charge the electric vehicles. Therefore, it is inevitable to install a large number of charging equipments.

Typically, for initial data installation of a new charging equipment placed at a desired location, a notebook computer is used to connect with the charging equipment, and is operable to transmit connection data wiredly, which is associated with connection between the charging equipment and an equipment management server located remotely with respect to the charging equipment, such as web address and port number of the equipment management server, to the charging equipment. Thereafter, when the charging equipment establishes a communication link with the equipment management server over a communication network, such as the Internet, based on the connection data, the equipment management server transmits installation data, which is associated with operation of the charging equipment, to the charging equipment through the communication link. For example, the installation data may include parameter data and firmware data, which are associated with operation of the charging equipment. Further, the equipment management server is operable to convert a geographical address corresponding to the location of the charging equipment into global positioning system (GPS) location data.

However, in such data installation, the connection data must be correctly inputted to the notebook computer by manual operation, and then, the installation data needs to be transmitted by the equipment management server to the charging equipment via the communication network. Therefore, for a mass of charging equipments to be data installed, manual input of the connection data is time-consuming, and data transmission loading of the equipment management server is increased. Furthermore, the GPS location data may not exactly represent the location of the charging equipment. Therefore, there is still room for improvement.

### SUMMARY OF THE INVENTION

Therefore, an object of the present invention is to provide a method and system for data installation that can overcome the aforesaid drawbacks of the prior art.

According to one aspect of the present invention, a system for data installation comprises a remote equipment, an equipment management server and a mobile device. The remote equipment is provided with a unique identification code. The equipment management server is located remotely with respect to the remote equipment, is connected to a communication network, and pre-stores installation data that corresponds to the unique identification code and that is associated with data installation of the remote equipment. The mobile device is connected to the communication network and is capable of short-distance wireless communication with the remote equipment. The mobile device is operable to acquire the unique identification code from the remote equipment.

Upon establishing a communication link between the mobile device and the equipment management server over the communication network, the mobile device transmits an installation request including the unique identification code to the equipment management server, and the equipment management server transmits the installation data to the mobile device in response to the installation request from the mobile device.

Upon establishing a short-distance wireless communication link between the mobile device and the remote equipment, the mobile device transmits the installation data to the remote equipment through the short-distance wireless communication link such that the remote equipment performs initial installation of the installation data.

According to another aspect of the present invention, there is provided a method for data installation implemented by a system that includes a remote equipment provided with a unique identification code, an equipment management server located remotely with respect to the remote equipment, and a mobile device. The method of this invention comprises the steps of:

a) the mobile device acquiring the unique identification code from the remote equipment;

b) upon establishing a communication link between the mobile device and the equipment management server, the mobile device transmitting an installation request that includes the unique identification code to the equipment management server;

c) upon receipt of the installation request from the mobile device, the equipment management server transmitting to the mobile device installation data that is pre-stored therein, that corresponds to the unique identification code and that is associated with data installation of the remote equipment; and

d) upon establishing a short-distance wireless communication link between the mobile device and the remote equipment, the mobile device transmitting the installation data to the remote equipment such that the remote equipment performs initial installation of the installation data.

According to still another aspect of the present invention, a system for data installation comprises a remote equipment and a portable electronic card. The remote equipment is configured with a unique identification code. The portable electronic card stores installation data that corresponds to the unique identification code and that is associated with data installation of the remote equipment. The portable electronic card is capable of short-distance wireless communication with the remote equipment.

Upon establishing a short-distance wireless communication link between the remote equipment and the portable electronic card, the remote equipment is operable to transmit a data request including the unique identification code to the portable electronic card, and the portable electronic card transmits the installation data corresponding to the unique identification code to the remote equipment in response to the data request from the remote equipment. The remote equipment performs initial data installation based on the installation data upon receipt of the installation data from the portable electronic card.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram illustrating the first preferred embodiment of a system for data installation according to the present invention;

FIG. 2 is a schematic block diagram illustrating a remote equipment and a mobile device of the system of the first preferred embodiment;

FIG. 3 is a flow chart illustrating the preferred embodiment of a method for data installation according to the present invention implemented by the system of the first preferred embodiment; and

FIG. 4 is a schematic block diagram illustrating the second preferred embodiment of a system for data installation according to the present invention.

### DETAILED DESCRIPTION OF THE PREFERRED EMBODIMENTS

Before the present invention is described in greater detail, it should be noted that like elements are denoted by the same reference numerals throughout the disclosure.

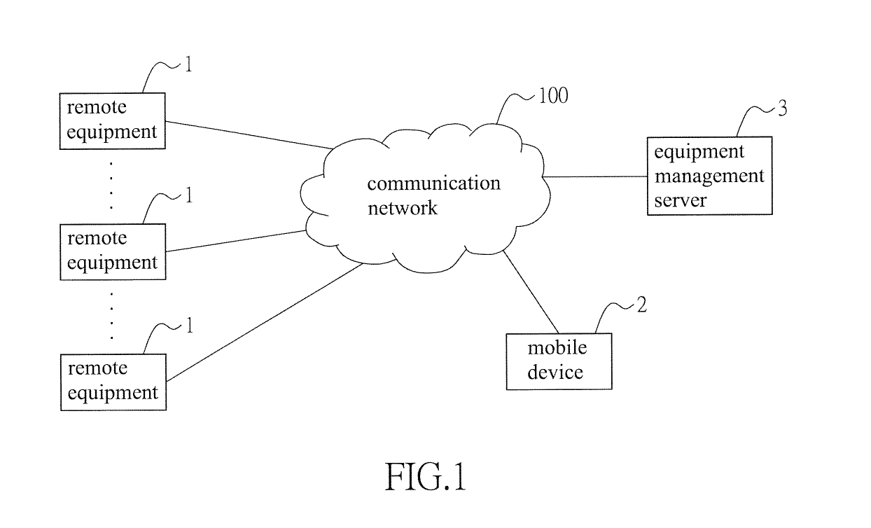

Referring to FIG. 1, the first preferred embodiment of a system for data installation according to the present invention is shown to include a plurality of remote equipments 1, a mobile device 2 and an equipment management server 3.

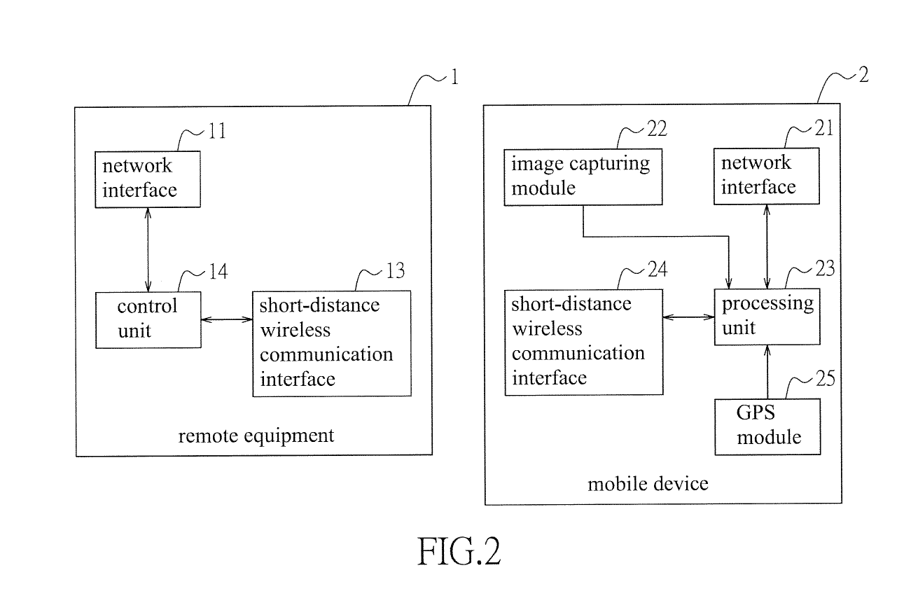

The remote equipments 1 may, for example, be charging equipments disposed in the same charging station. Each remote equipment 1 is provided with a unique identification code. In this embodiment, the unique identification code of each remote equipment 1 is in the form of a two-dimensional bar code pattern (not shown), such as a QR code pattern, disposed on the remote equipment 1. Referring further to FIG. 2, each remote equipment 1 includes a network interface 11 connected to a communication network 100, such as the Internet, a short-distance wireless communication interface 13, and a control unit 14 coupled to the network interface and the short-distance wireless communication interface 13.

The equipment management server 3 is located remotely with respect to the remote equipments 1, is connected to the communication network 100, and pre-stores a plurality of installation data, each of which corresponds to the unique identification code of a respective remote equipment 1 and is associated with data installation of the respective remote equipment 1. In this embodiment, initially, each of the plurality of installation data includes connection data that is associated with connection between the respective remote equipment 1 and the equipment management server 3, and parameter data and firmware data that are associated with operation of the respective remote equipment 1.

The mobile device 2 may, for example, be a smart phone, a tablet computer or a mobile communication device. Referring again to FIG. 2, in this embodiment, the mobile device 2 includes a network interface 21 connected to the communication network 100 (see FIG. 1), an image capturing module 22, a short-distance wireless communication interface 24, a global positioning system (GPS) module 25, and a processing unit 23 coupled to the network interface 21, the image capturing module 22, the short-distance wireless communication interface 24 and the GPS module 25. The mobile device 2 is capable of wireless communication with each remote equipment 1 when in close proximity thereto. It is noted that the short-distance wireless communication interface 13 of each remote equipment 1 and the short-distance wireless communication interface 24 of the mobile device 2 may use near field communication (NFC), Bluetooth, wireless fidelity (Wi-Fi) or infrared data association (IrDA) technology.

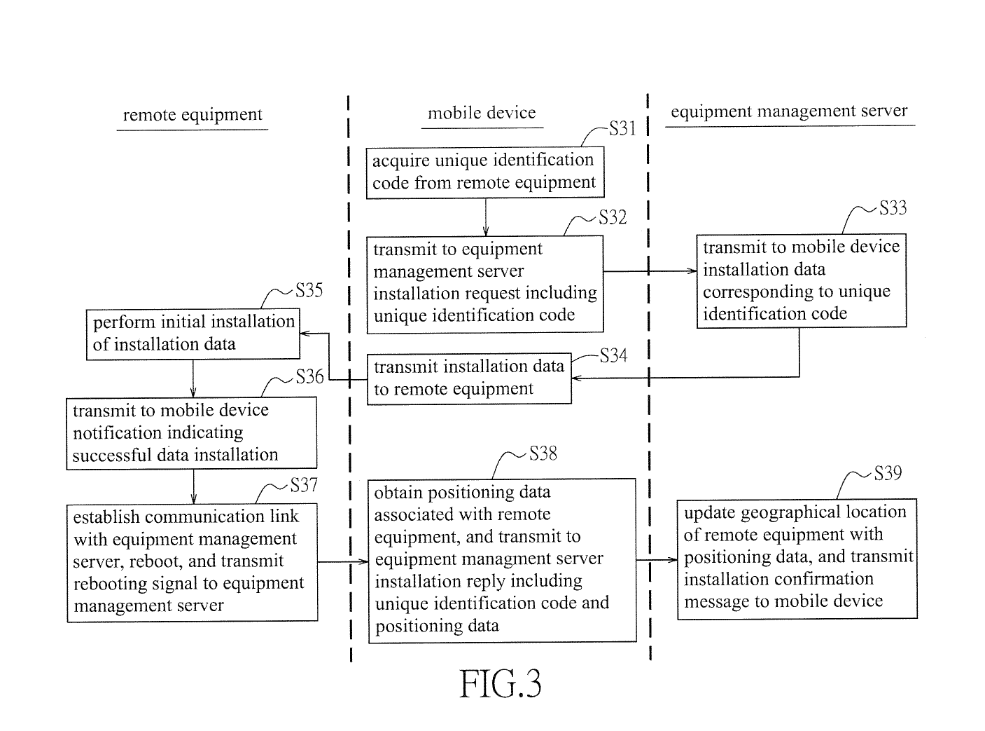

FIG. 3 is a flow chart illustrating how the system of FIG. 1 implements the preferred embodiment of a method for data installation according to the present invention.

In step S31, the mobile device 2 acquires the unique identification code from one remote equipment 1. In this embodiment, the image capturing module 22 of the mobile device 2 captures an image of the two-dimensional bar code pattern, and outputs the captured image to the processing unit 23. Then, the processing unit 23 processes the captured image in a known manner so as to obtain the unique identification code.

In step 332, when the mobile device 2 establishes a communication link with the equipment management server 3 using the network interface 21, the mobile device 2 transmits an installation request including the unique identification code to the equipment management server 3 through the communication link.

In step S33, upon receipt of the installation request from the mobile device 3, the equipment management server 3 transmits to the mobile device 2 the installation data corresponding to the unique identification code through the communication link.

In step S34, when the mobile device 2 is in close proximity to the remote equipment 1 to establish a short-distance wireless communication link with the remote equipment 1 using the short-distance wireless communication interfaces 24, 13, the mobile device 2 transmits the installation data to the remote equipment 1. In this embodiment, the remote equipment 1 first transmits a data request to the mobile device 2 through the short-distance wireless communication link, and the mobile device 2 transmits the installation data to the remote equipment 1 in response to the data request from the remote equipment 1.

In step S35, upon receipt of the installation data from the mobile device 2, the remote equipment 1 performs initial installation of the installation data.

In step S36, when installation of the installation data is successful, the remote equipment 1 is operable to transmit a notification indicating successful data installation to the mobile device 2 through the short-distance wireless communication link.

In step S37, the remote equipment 1 is operable to establish a communication link with the equipment management server 3 over the communication network 100 based on the connection data of the installation data, to reboot based on the parameter data and the firmware data of the installation data, and to transmit a rebooting signal to the equipment management server 3.

In step S38, when the mobile device 2 receives the notification transmitted from the remote equipment 1 in step S36, the mobile device 2 is preferably moved as close as possible to the remote equipment 1. At the same time, the GPS module 25 of the mobile device 2 is operable to obtain positioning data associated with the remote equipment 1 by acquiring the location of the mobile device 2 in close proximity to the remote equipment 1. Then, the mobile device 2 is operable to transmit to the equipment management server 3 an installation reply that includes the positioning data and the unique identification code of the remote equipment 1.

In step S39, when the equipment management server 3 receives the rebooting signal from the remote equipment 1 and the installation reply from the mobile device 2, the equipment management server 3 is operable to update a geographical location of the remote equipment 1 with the positioning data, and to transmit an installation confirmation message to the mobile device 2. Thereafter, upon receipt of the installation confirmation message from the equipment management server 3, the mobile device 2 can proceed to perform initial data installation for another remote equipment 1 in the same manner.

In such a configuration, due to the presence of the mobile device 2, the installation data for each remote equipment 1, including the connection data, the parameter data and the firmware data, can be correctly and easily transmitted to the remote equipment 1 using short-distance wireless communication without manual input and connection operations. In addition, the equipment management server 3 can effectively confirm initial data installation for each remote equipment 1. Further, the equipment manage server 3 can obtain relatively accurate location data of each remote equipment 1 compared to the prior art. Alternatively, it is noted that the mobile device 2 can also obtain the plurality of installation data corresponding respectively to the identification codes of all the remote equipments 1 at the outset. Then, steps S31 and S34˜S39 are performed repeatedly. In this way, transmission loading on the communication network 100 for the installation data for all the remote equipments 1 is reduced.

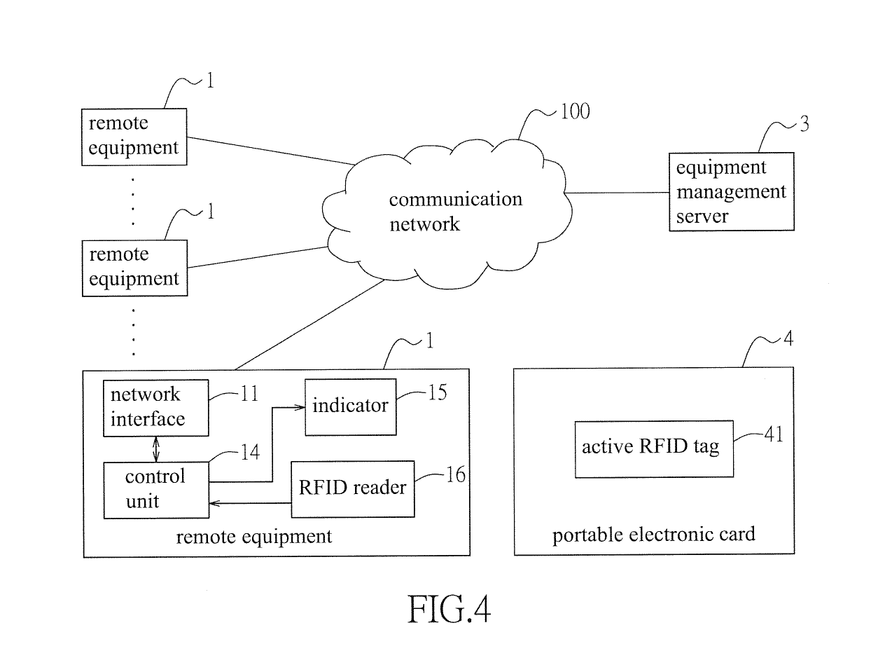

FIG. 4 illustrates the second preferred embodiment of a system for data installation according to this invention, which is a modification of the first preferred embodiment. In this embodiment, a portable electronic card 4 is used to replace the mobile device 2 of the first preferred embodiment (FIG. 1). The portable electronic card 4 includes an embedded active radio frequency identification (REID) tag 41.

Initially, the equipment management server 3 is operable to write the plurality of installation data corresponding respectively to the identification codes of the remote equipments 1 into the active REID tag 41. Thus, the plurality of installation data is stored in the portable electronic card 4.

In additional, each remote equipment 1 further includes an REID reader 16 and an indicator 15 coupled to the control unit 14.

When the portable electronic card 4 is in close proximity to one remote equipment 1 to establish a short-distance wireless communication link therewith, the REID reader 16 of the remote equipment 1 transmits a data request including the unique identification code to the portable electronic card 4, and the portable electronic card 4 transmits the installation data corresponding to the unique identification code to the remote equipment 1 in response to the data request from the remote equipment 1, i.e., the RFID reader 16 reads the installation data from the active RFID tag 41 of the portable electronic card 4. Thereafter, the remote equipment 1 performs initial installation of the installation data. When installation of the installation data is successful, the control unit 14 of the remote equipment 1 is operable to enable the indicator 15 to generate an indicating output, e.g., a light or sound output. Similarly, the remote equipment 1 is operable to reboot based on the parameter data and the firmware data of the installation data and to transmit a rebooting signal to the equipment management server 3 when a communication link between the remote equipment 1 and the equipment management server 3 over the communication network 100 is established based on the connection data of the installation data.

In such a configuration, each of the plurality of installation data can be correctly and easily transmitted to a respective remote equipment 1 using RFID technology without manual input and connection operations. Similarly, transmission loading on the communication network 100 for the installation data for all the remote equipments 1 is reduced.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system for data installation comprising:
a remote equipment provided with a unique identification code;
an equipment management server located remotely with respect to said remote equipment, connected to a communication network and pre-storing installation data that corresponds to the unique identification code and that is associated with data installation of said remote equipment; and
a mobile device connected to the communication network and capable of short-distance wireless communication with said remote equipment, said mobile device being operable to acquire the unique identification code from said remote equipment.

2. The system as claimed in claim 1, wherein, upon establishing a communication link between said mobile device and said equipment management server over the communication network, said mobile device transmits an installation request including the unique identification code to said equipment management server, and said equipment management server transmits the installation data to said mobile device in response to the installation request from said mobile device; and
wherein, upon establishing a short-distance wireless communication link between said mobile device and said remote equipment, said mobile device transmits the installation data to said remote equipment through the short-distance wireless communication link such that said remote equipment performs initial installation of the installation data.

3. The system as claimed in claim 2, wherein:
the unique identification code is in the form of a two-dimensional bar code pattern disposed on said remote equipment; and
said mobile device includes an image capturing module for capturing an image of said two-dimensional bar code pattern, and a processor coupled to said image capturing module for receiving the captured image therefrom and operable to process the captured image so as to obtain the unique identification code.

4. The system as claimed in claim 2, wherein, when said mobile device is in close proximity to said remote equipment to establish the short-distance wireless communication link therewith, said remote equipment is operable to transmit a data request to said mobile device through the short-distance wireless communication link, and said mobile device transmits the installation data to said remote equipment in response to the data request received thereby.

5. The system as claimed in claim 2, wherein the installation data includes connection data that is associated with connection between said remote equipment and said equipment management server, and parameter data and firmware data that are associated with operation of said remote equipment.

6. The system as claimed in claim 5, wherein:
when installation of the installation data is successful, said remote equipment is operable to transmit a notification indicating successful data installation to said mobile device through the short-distance wireless communication link, to reboot based on the parameter data and the firmware data of the installation data, and to transmit a rebooting signal to said equipment management server when a communication link between said remote equipment and said equipment management server over the communication network is established based on the connection data of the installation data;
said mobile device further includes a global positioning system (GPS) module that is operable to obtain positioning data associated with said remote equipment by acquiring location of said mobile device in close proximity to said remote equipment upon receipt of the notification from said remote equipment, and is operable to transmit to said equipment management server an installation reply that includes the positioning data and the unique identification code of said remote equipment; and
upon receipt of the rebooting signal from said remote equipment and the installation reply from said mobile device, said equipment management server is operable to update a geographical location of said remote equipment with the positioning data, and to transmit an installation confirmation message to said mobile device via the communication network.

7. A method for data installation implemented by a system that includes a remote equipment provided with a unique identification code, an equipment management server located remotely with respect to the remote equipment, and a mobile device, said method comprising the steps of:
a) the mobile device acquiring the unique identification code from the remote equipment;
b) upon establishing a communication link between the mobile device and the equipment management server, the mobile device transmitting an installation request that includes the unique identification code to the equipment management server;
c) upon receipt of the installation request from the mobile device, the equipment management server transmitting to the mobile device installation data that is pre-stored therein, that corresponds to the unique identification code and that is associated with data installation of the remote equipment; and
d) upon establishing a short-distance wireless communication link between the mobile device and the remote equipment, the mobile device transmitting the installation data to the remote equipment such that the remote equipment performs initial installation of the installation data.

8. The method as claimed in claim 7, the unique identification code being in the form of a two-dimensional bar code pattern disposed on the remote equipment, wherein step a) includes the sub-steps of:
a1) the mobile device capturing an image of the two-dimensional bar code pattern; and
a2) the mobile device processing the captured image so as to obtain the unique identification code.

9. The method as claimed in claim 7, wherein, in step d), the remote equipment first transmits a data request to the mobile device through the short-distance wireless communication link, and the mobile device transmits the installation data to the remote equipment in response to the data request from the remote equipment.

10. The method as claimed in claim 7, wherein the installation data includes connection data that is associated with connection between the remote equipment and the equipment management server, and parameter data and firmware data that are associated with operation of the remote equipment.

11. The method as claimed in claim 10, further comprising the steps of:
e) when installation of the installation data is successful, the remote equipment transmitting a notification that indicates successful data installation to the mobile device through the short-distance wireless communication link;
f) the remote equipment establishing a communication link with the equipment management server over the communication network based on the connection data of the installation data, and transmitting a rebooting signal to the equipment management server after rebooting based on the parameter data and the firmware data of the installation data;
g) upon receipt of the notification transmitted from the remote equipment in step e), the mobile device obtaining positioning data that is associated with the remote equipment using global positioning system (GPS) technology, and transmitting to the equipment management server an installation reply that includes the positioning data and the unique identification code of the remote equipment; and
h) upon receipt of the rebooting signal transmitted from the remote equipment in step f) and the installation reply transmitted from the mobile device in step g), the equipment management server updating a geographical location of the remote equipment with the positioning data, and transmitting an installation confirmation message to the mobile device.

12. A system for data installation, comprising:
a remote equipment provided with a unique identification code; and
a portable electronic card storing installation data that corresponds to the unique identification code and that is associated with installation of said remote equipment, said portable electronic card being capable of short-distance wireless communication with said remote equipment;
wherein, upon establishing a short-distance wireless communication link between said remote equipment and said portable electronic card, said remote equipment is operable to transmit a data request including the unique identification code to said portable electronic card, and said portable electronic card transmits the installation data corresponding to the unique identification code to said remote equipment in response to the data request from said remote equipment, said remote equipment performing initial installation of the installation data upon receipt of the installation data from said portable electronic card.

13. The system as claimed in claim 12, further comprising an equipment management server located remotely with respect to said remote equipment and pre-storing the installation data that corresponds to the unique identification code, the installation data being previously written from said equipment management server into said portable electronic card such that the installation data is stored in said portable electronic card.

14. The system as claimed in claim 13, wherein the installation data includes connection data that is associated with connection between said remote equipment and said equipment management server, and parameter data and firmware data that are associated with operation of said remote equipment.

15. The system as claimed in claim 14, wherein:
said remote equipment further includes an indicator for generating an indicating output when installation of the installation data is successful; and
said remote equipment is operable to reboot based on the parameter data and the firmware data of the installation data, and to transmit a rebooting signal to said equipment management server when a communication link between said remote equipment and said equipment management server over a communication network is established based on the connection data of the installation data.
